(19) United States
(12) Patent Application Publication
(10) Pub. No.: US 2015/0373720 A1
(43) Pub. Date: Dec. 24, 2015

(54) MOBILE STATION AND MOBILE COMMUNICATION SYSTEM

(71) Applicant: NTT DOCOMO, INC., Tokyo (JP)

(72) Inventors: Tooru Uchino, Tokyo (JP); Hideaki Takahashi, Tokyo (JP)

(73) Assignee: NTT DOCOMO, INC., Tokyo (JP)

(21) Appl. No.: 14/766,248

(22) PCT Filed: Feb. 19, 2014
(86) PCT No.: PCT/JP2014/053909

§ 371 Date: Aug. 6, 2015

(30) Foreign Application Priority Data
Feb. 26, 2013 (JP) 2013-035877

(51) Int. Cl. H04W 72/04; H04W 16/14; H04W 76/02

(52) U.S. Cl. CPC H04W 72/0453; H04W 76/025; H04W 16/14

(57) ABSTRACT

An appropriate operation in implementation of “inter-eNB CA” is performed. A mobile station UE according to the present invention includes: a generation unit 11 configured to generate a signal to be transmitted; and a judgment unit 12 configured to change a target radio base station eNB for transmission of the signal based on the type of the signal.

### TECHNICAL FIELD

The present invention relates to a mobile station and a mobile communication system.

### BACKGROUND ART

In LTE (Long Term Evolution) Release 10, a type of CA (carrier aggregation), i.e., “intra-eNB CA” has been introduced in order to realize broadband communications exceeding 20 MHz (e.g., communications in 100 MHz). In “intra-eNB CA”, communications are performed while multiple CCs (component carriers) under control of the same radio base station eNB are aggregated.

Then, in LTE Release 12 and beyond, “small cell enhancement” has been proposed, and the introduction of “inter-eNB CA” is currently under study as one type of network architecture more flexible than ever. In “inter-eNB CA”, communications are performed while multiple CCs (cells) under control of different radio base stations eNB are aggregated.

For example, in one of conceivable operations using “inter-eNB CA,” communication of a control signal (C-plane signal) requiring reliability is performed in a cell #1 (macro cell) under control of a radio base station eNB#1 via an SRB (signaling radio bearer), and communication of a user data signal (U-plane signal) requiring broadband communication is performed in a cell #11 (small cell) under control of a radio base station eNB#11 via a DRB (Data Radio Bearer).

### PRIOR ART DOCUMENT

### Non-Patent Document

Non-patent document 1: 3GPP TS36.300

### SUMMARY OF THE INVENTION

However, there are problems that, at present, no study has been carried out on what kind of operation scenario is appropriate for “inter-eNB CA,” and no study has been carried out on the specification of a mobile station UE required for realizing the scenario either.

The present invention has been therefore made in view of the above problems and an objective thereof is to provide a mobile station and a mobile communication system capable of performing an appropriate operation for “inter-eNB CA.”

A first feature of the present invention is summarized as a mobile station including: a generation unit configured to generate a signal to be transmitted; and a judgment unit configured to change a target radio base station for transmission of the signal based on a type of the signal.

A second feature of the present invention is summarized as a mobile communication system including a first radio base station and a second radio base station. Here, the first radio base station controls a macro cell, the second radio base station controls a small cell, in downlink, the first radio base station transmits a user data signal to a mobile station, in uplink, the mobile station transmits a user data signal to the second radio base station, an acknowledgment signal for the user data signal in the downlink is transmitted from the mobile station to the first radio base station, and an acknowledgment signal for the user data signal in the uplink is transmitted from the second radio base station to the mobile station.

### BRIEF DESCRIPTION OF THE DRAWINGS

FIG. 1 is an overall configuration diagram of a mobile communication system according to a first embodiment of the present invention.

FIG. 2 is a functional block diagram of a mobile station according to the first embodiment of the present invention.

FIG. 3 is a chart for explaining a method of judging a target for signal transmission, the judgment being made by the mobile station according to the first embodiment of the present invention.

FIG. 4 is a chart for explaining a method of judging a target for signal transmission, the judgment being made by the mobile station according to the first embodiment of the present invention.

FIG. 5 is a chart for explaining a method of judging a target for signal transmission, the judgment being made by the mobile station according to the first embodiment of the present invention.

FIG. 6 is a flowchart illustrating the workings of the mobile station according to the first embodiment of the present invention.

FIG. 7 is an overall configuration diagram of a mobile communication system according to a first modified example of the present invention.

### MODE FOR CARRYING OUT THE INVENTION

### Mobile Communication System According to First Embodiment of Present Invention

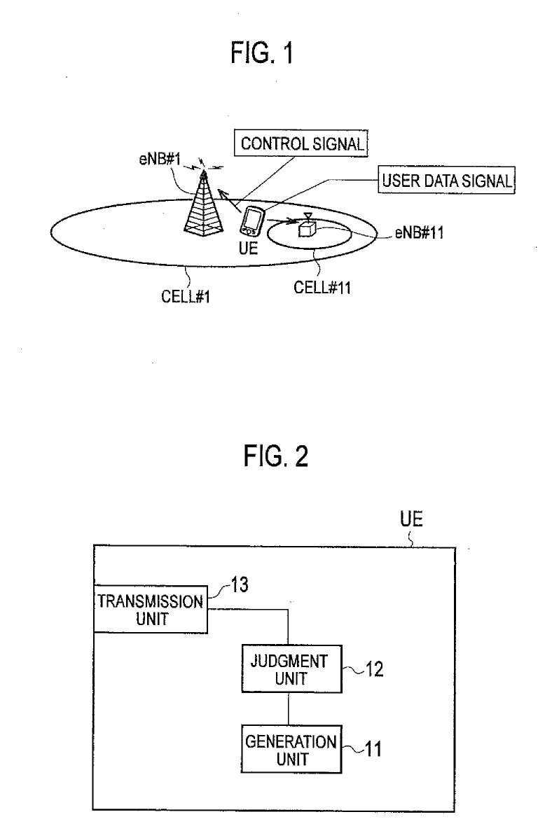

A mobile communication system according to a first embodiment of the present invention is described with reference to FIGS. 1 to 6.

As illustrated in FIG. 1, the mobile communication system according to this embodiment includes a radio base station eNB#1 that controls a cell #1 and a radio base station eNB#11 that controls a cell #11.

Here, the cell #11 is a small cell (phantom cell) and the cell #1 is a macro cell. Note that the cell #1 and the cell #11 are arranged so that the coverage area of the cell #11 and the coverage area of the cell #1 may overlap each other at least partially.

Note that the radio base station eNB#1 may be called a macro radio base station (Macro-eNB) and the radio base station eNB#11 may be called a small radio base station (Small-eNB) or a phantom radio base station (Phantom-eNB).

In addition, the mobile communication system according to this embodiment is an LTE mobile communication system, and the mobile station UE is configured to be capable of carrying out “inter-eNB CA.”

Note that, in the mobile communication system according to this embodiment, the mobile station UE carries out “inter-eNB CA” via the cell #1 under control of the radio base station eNB#1 and the cell #11 under control of the radio base station eNB#11.

As illustrated in FIG. 2, the mobile station UE according to this embodiment includes a generation unit 11, a judgment unit 12, and a transmission unit 13.

The generation unit 11 is configured to generate signals (a user data signal and a control signal) to be transmitted by the mobile station UE.

The judgment unit 12 is configured to determine a target radio base station eNB to which the signal generated by the generation unit 11 is to be transmitted.

Here, the judgment unit 12 is configured to change a target radio base station eNB for transmission of the signal generated by the generation unit 11, on the basis of the type of the signal.

Specifically, the judgment unit 12 may be configured to set different target radio base stations eNB for transmission of a user data signal and for transmission of a control signal.

Alternatively, a radio base station eNB may be configured to designate a target radio base station for signal transmission for every signal type.

Note that the judgment unit 12 may be configured to judge that, if no such designation as to a certain signal is made by the radio base station, the certain signal is to be transmitted uniformly to a specific radio base station eNB (to an anchor radio base station eNB, for example).

Here, the anchor radio base station eNB may be a radio base station eNB which has established an interface with the CN (Core Network), may be a radio base station eNB which has an RRC layer function, or may be a radio base station eNB which has a security function.

In addition, the mobile station UE may be configured to transmit a signal uniformly to the specific radio base station eNB also when the setting (configuration) currently set is released (e.g., in a re-connection procedure or a handover procedure).

The radio base station eNB may be configured to make the designation described above by using a signal in any of the RRC layer, PDCP layer, RLC layer, MAC layer, and physical layer.

Further, the mobile station UE may notify a radio base station eNB of the number of radio base stations eNB that are settable in the mobile station UE as signal transmission targets. The notification may be made on a per-layer basis or on a per-signal-type basis.

For example, the judgment unit 12 may be configured to set the radio base station eNB#11 as a target radio base station eNB for transmission of a user data signal and set the radio base station eNB#1 as a target radio base station eNB for transmission of a control signal.

In addition, the judgment unit 12 may be configured to change a target radio base station eNB for transmission of a control signal generated by the generation unit 11, on the basis of the type of the control signal.

Here, a MAC-PDU (Protocol Data Unit) generated by the MAC (Media Access Control) layer of the generation unit 11 includes a MAC subheader and its payload (see 3GPP TS36.321).

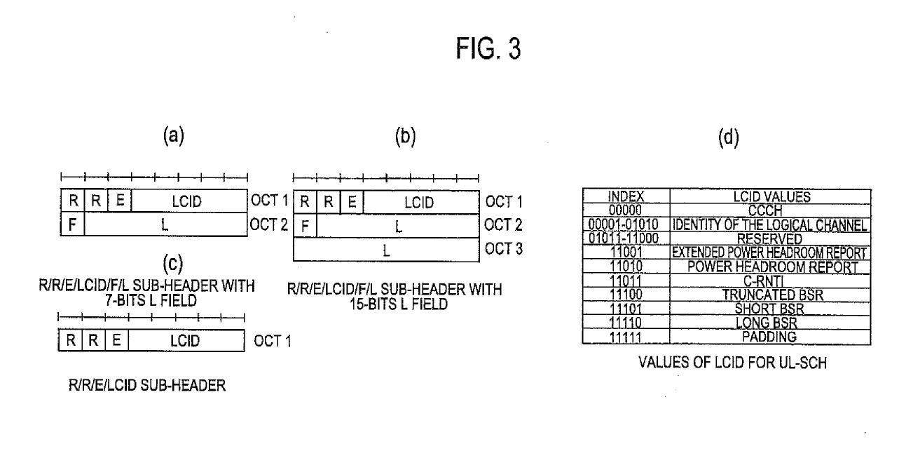

As illustrated in FIGS. 3(a) to 3(c), a MAC subheader includes an LCID (Logical Channel ID) indicating which of user data and a MAC-CE (Control Element) is stored in its subsequent payload.

Thus, the judgment unit 12 is configured to judge the type of a signal generated by the generation unit 11, e.g., judge whether the signal is a user data signal which includes a MAC-PDU including user data or a control signal which includes a MAC-PDU including a MAC-CE, on the basis of the LCID in a MAC subheader.

Here, there are several types of MAC-CEs as illustrated in FIG. 3(d). The judgment unit 12 may be configured to change a target radio base station eNB for transmission of a control signal for every type of MAC-CE, the control signal including a MAC-PDU including the MAC-CE.

Note that, as illustrated in FIG. 3(d), a MAC-PDU specified as “LCID=00001−01010” is configured to include user data, and MAC-PDUs specified as “LCID=11001/11010/11011/11100/11101/11110” are configured to include MAC-CEs.

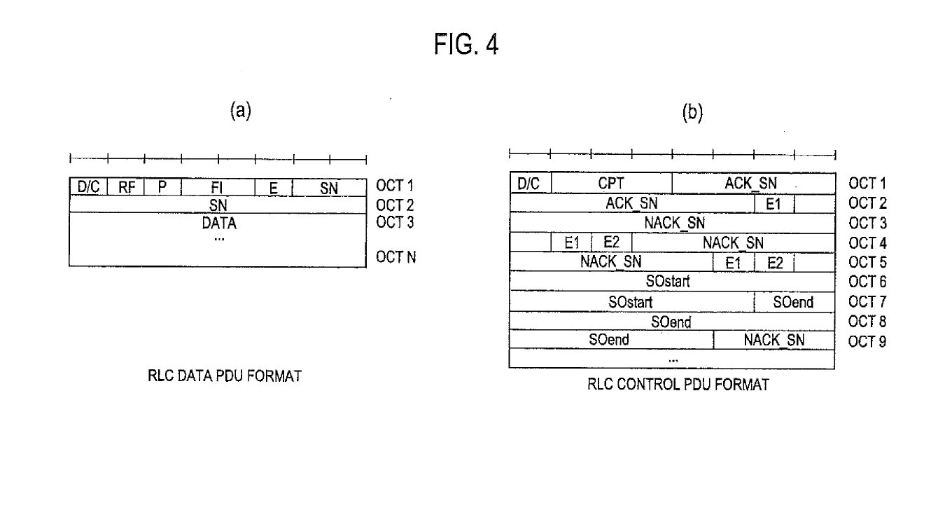

Besides, RLC-PDUs generated by the RLC (Radio Link Control) layer of the generation unit 11 are broadly classified into an “RLC data PDU (see FIG. 4(a))” and an “RLC control PDU (see FIG. 4(b))” (see 3GPP TS36.322).

As illustrated in FIG. 4(a) and FIG. 4(b), the judgment unit 12 is configured to judge the type of a signal generated by the generation unit 11, e.g., judge whether the signal is a user data signal which includes an “RLC data PDU” or a control signal which includes an “RLC control PDU,” on the basis of the D/C field in the first bit of an RLC-PDU.

Here, there are several types of “RLC control PDUs.” As illustrated in FIG. 4(b), the judgment unit 12 may be configured to judge the type of “RLC control PDU” on the basis of its CPT field, and to change a target radio base station eNB for transmission of a control signal for every type of “RLC control PDU,” the control signal including the “RLC control PDU.”

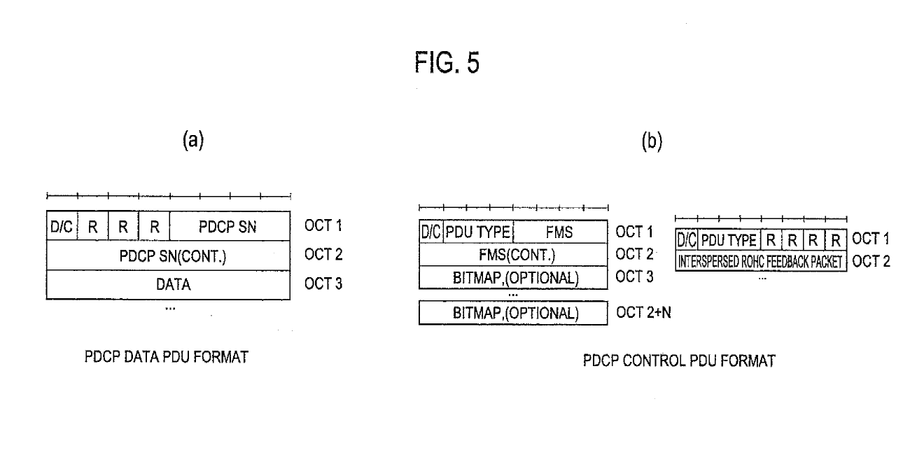

Besides, PDCP-PDUs generated by the PDCP (Packet Data Convergence Protocol) layer of the generation unit 11 are broadly classified into a “PDCP data PDU (see FIG. 5(a))” and a “PDCP control PDU (see FIG. 5(b))” (see 3GPP TS36.323).

As illustrated in FIG. 5(a) and FIG. 5(b), the judgment unit 12 is configured to judge the type of a signal generated by the generation unit 11, e.g., judge whether the signal is a user data signal which includes a “PDCP data PDU” or a control signal which includes a “PDCP control PDU,” on the basis of the D/C field in the first bit of a PDCP-PDU.

Here, there are several types of “PDCP control PDUs.” As illustrated in FIG. 5(b), the judgment unit 12 may be configured to judge the type of “PDCP control PDU” on the basis of its “PDU Type” field, and to change a target radio base station eNB for transmission of a control signal for every type of “PDCP control PDU,” the control signal including the “PDCP control PDU.”

The transmission unit 13 is configured to transmit a signal (a user data signal or a control signal) generated by the generation unit 12 to a transmission target radio base station eNB determined by the judgment unit 12.

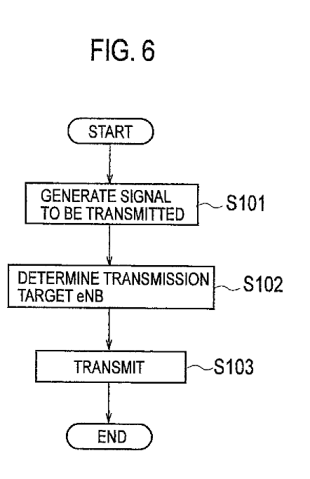

Hereinbelow, with reference to FIG. 6, description is given of the workings of the mobile communication system according to this embodiment, more specifically, the workings of the mobile station UE according to the embodiment.

As illustrated in FIG. 6, in Step S101, the mobile station UE generates a signal (a user data signal or a control signal) to be transmitted.

In Step S102, the mobile station UE determines a target radio base station eNB for transmission of the signal, on the basis of the type of the signal.

In Step S103, the mobile station UE transmits the signal based on the determination result.

### First Modified Example

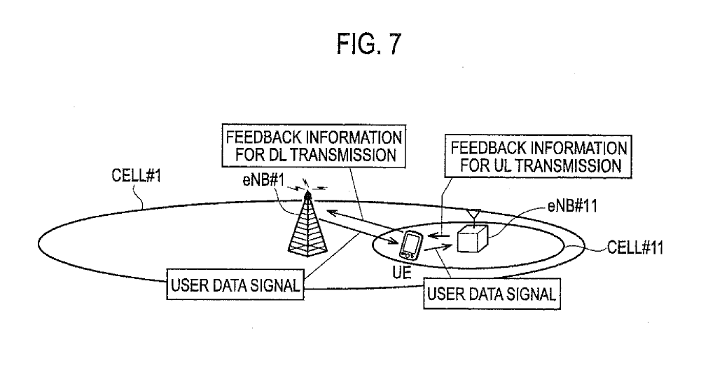

Hereinbelow, with reference to FIG. 7, a mobile communication system according to a first modified example of the present invention is described mainly in terms of differences from the mobile communication system according to the first embodiment.

The mobile communication system according to the first modified example is configured such that, in implementation of “inter-eNB CA,” transmission of a user data signal in uplink and transmission of a downlink user data signal in downlink are carried out via different radio base stations eNB.

Specifically, the mobile communication system according to the first modified example is configured such that the radio base station eNB#1 transmits a user data signal to the mobile station UE in downlink and the mobile station UE transmits a user data signal to the radio base station eNB#11 in uplink.

In other words, in downlink, a user data signal is transmitted in the cell #1 being a macro cell in which the signal is more likely to be received by the mobile station UE, and in uplink, a user data signal is transmitted to the cell #11 being a small cell so that transmission by the mobile station UE is made at low power and thereby battery saving is enabled.

In addition, in the mobile communication system according to the first modified example, the radio base station eNB#1 and the radio base station eNB#11 respectively have schedulers and an acknowledgment signal (ACK/NACK) for each of the user data signals described above needs to be transmitted to the corresponding target for transmission of the user data signal.

Accordingly, the mobile communication system according to the first modified example is configured such that an acknowledgment signal for the user data signal in downlink is transmitted from the mobile station UE to the radio base station eNB#1 and an acknowledgment signal for the user data signal in uplink is transmitted from the radio base station eNB#11 to the mobile station UE.

The features of the present embodiment may also be expressed as follows.

A first feature of the present embodiment is summarized as a mobile station UE including: a generation unit 11 configured to generate a signal to be transmitted; and a judgment unit 12 configured to change a target radio base station eNB for transmission of the signal based on a type of the signal.

According to the configuration described above, a target radio base station eNB for signal transmission is flexibly changed in implementation of “inter-eNB CA,” thereby realizing an appropriate operation in consideration of a communication status.

In the first feature of the present embodiment, the judgment unit 12 may set different target radio base stations eNB for transmission of a user data signal and for transmission of a control signal.

According to the configuration described above, in implementation of “inter-eNB CA,” the mobile station UE transmits a user data signal to the cell #11 being a small cell to reduce transmission power in the mobile station UE and realize battery saving, and transmits a control signal to the cell #1 being a macro cell to realize reliable processing on the control signal by the radio base station eNB#1.

In the first feature of the present embodiment, the judgment unit 12 may change a target radio base station eNB for transmission of the control signal based on a type of the control signal.

According to the configuration described above, a target radio base station eNB for transmission of a control signal is changed based on the type of the control signal in implementation of “inter-eNB CA,” thereby realizing an appropriate operation while a communication status is taken into consideration more flexibly.

In the first feature of the present embodiment, the judgment unit 12 may judge the type of the signal based on an LCID in a MAC subheader.

According to the configuration described above, it is possible to realize an appropriate operation in consideration of a communication status without changing the existing specification.

In the first feature of the present embodiment, the judgment unit 12 may judge the type of the signal based on a D/C field in a first bit of an RLC-PDU.

According to the configuration described above, it is possible to realize an appropriate operation in consideration of a communication status without changing the existing specification.

In the first feature of the present embodiment, the judgment unit 12 may judge the type of the signal based on a D/C field in a first bit of a PDCP-PDU.

According to the configuration described above, it is possible to realize an appropriate operation in consideration of a communication status without changing the existing specification.

In the first feature of the present embodiment, the judgment unit 12 may determine a target radio base station eNB for transmission of each signal according to an instruction from a radio base station eNB.

In the first feature of the present embodiment, if the instruction as to a certain signal does not exist, the judgment unit 12 may determine a specific radio base station (anchor radio base station eNB) as a target radio base station eNB for transmission of the certain signal.

In the first feature of the present embodiment, when a setting (configuration) currently set is released, the judgment unit 12 may determine a specific radio base station (anchor radio base station eNB) as a target radio base station eNB for transmission of the signal.

In the first feature of the present embodiment, the mobile station UE may further include a transmission unit 13 configured to notify a radio base station eNB of the number of radio base stations eNB that are settable in the mobile station UE as a target radio base station eNB for transmission of the signal.

A second feature of the present embodiment is summarized as a mobile communication system including a radio base station eNB#1 (first radio base station) and a radio base station eNB#11 (second radio base station). Here, the radio base station eNB#1 controls a cell #1 (macro cell), the radio base station eNB#11 controls a cell #11 (small cell), in downlink, the radio base station eNB#1 transmits a user data signal to a mobile station UE, in uplink, the mobile station UE transmits a user data signal to the radio base station eNB#11, an acknowledgment signal (ACK/NACK) for the user data signal in the downlink is transmitted from the mobile station UE to the radio base station eNB#1, and an acknowledgment signal (ACK/NACK) for the user data signal in the uplink is transmitted from the radio base station eNB#11 to the mobile station UE.

According to the configuration described above, in downlink, security in communications can be achieved by transmitting a user data signal in the cell #1 being a macro cell in which the signal is more likely to be received by the mobile station UE, and in uplink, transmission power in the mobile station UE can be made lower and thereby battery saving can be realized.

It should be noted that the foregoing operations of the mobile stations UE and radio base stations eNB#1/eNB#11 may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the mobile stations UE and radio base stations eNB#1/eNB#11. Otherwise, the storage medium and the processor may be provided as discrete components inside the mobile stations UE and radio base stations eNB#1/eNB#11.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2013-035877 (filed on Feb. 26, 2013) is incorporated by reference in the present specification.

### INDUSTRIAL APPLICABILITY

As has been described above, the present invention can provide a mobile station and a mobile communication system capable of performing an appropriate operation in implementation of “inter-eNB CA.”

### EXPLANATION OF THE REFERENCE NUMERALS

UE mobile station
11 generation unit
12 judgment unit
13 transmission unit

1. A mobile station comprising:
a generation unit configured to generate a signal to be transmitted; and
a judgment unit configured to change a target radio base station for transmission of the signal based on a type of the signal.

2. The mobile station according to claim 1, wherein the judgment unit sets different target radio base stations for transmission of a user data signal and for transmission of a control signal.

3. The mobile station according to claim 2, wherein the judgment unit changes a target radio base station for transmission of the control signal based on a type of the control signal.

4. The mobile station according to claim 1, wherein the judgment unit judges the type of the signal based on an LCID in a MAC subheader.

5. The mobile station according to claim 1, wherein the judgment unit judges the type of the signal based on a D/C field in a first bit of an RLC-PDU.

6. The mobile station according to claim 1, wherein the judgment unit judges the type of the signal based on a D/C field in a first bit of a PDCP-PDU.

7. The mobile station according to claim 1, wherein the judgment unit determines a target radio base station for transmission of each signal according to an instruction from a radio base station.

8. The mobile station according to claim 7, wherein, if the instruction as to a certain signal does not exist, the judgment unit determines a specific radio base station as a target radio base station for transmission of the certain signal.

9. The mobile station according to claim 1, wherein, when a setting currently set is released, the judgment unit determines a specific radio base station as a target radio base station for transmission of the signal.

10. The mobile station according to claim 1, further comprising a transmission unit configured to notify a radio base station of the number of radio base stations that are settable in the mobile station as a target radio base station for transmission of the signal.

11. A mobile communication system comprising a first radio base station and a second radio base station, wherein
the first radio base station controls a macro cell,
the second radio base station controls a small cell,
in downlink, the first radio base station transmits a user data signal to a mobile station,
in uplink, the mobile station transmits a user data signal to the second radio base station,
an acknowledgment signal for the user data signal in the downlink is transmitted from the mobile station to the first radio base station, and
an acknowledgment signal for the user data signal in the uplink is transmitted from the second radio base station to the mobile station.

12. The mobile station according to claim 2, wherein the judgment unit judges the type of the signal based on an LCID in a MAC subheader.

13. The mobile station according to claim 3, wherein the judgment unit judges the type of the signal based on an LCID in a MAC subheader.

14. The mobile station according to claim 2, wherein the judgment unit judges the type of the signal based on a D/C field in a first bit of an RLC-PDU.

15. The mobile station according to claim 3, wherein the judgment unit judges the type of the signal based on a D/C field in a first bit of an RLC-PDU.
